(19) United States
(12) Patent Application Publication
(10) Pub. No.: US 2010/0032537 A1
(43) Pub. Date: Feb. 11, 2010

(54) Combined yoga strap and mat

(76) Inventor: Elizabeth M. Andrews, Flossmoor, IL (US)

Correspondence Address: PYLE & PIONTEK, LLC, 221 N LASALLE STREET , ROOM 1207, CHICAGO, IL, 60601, US

(21) Appl. No.: 12/462,584

(22) Filed: Aug. 5, 2009

Related U.S. Application Data
(60) Provisional application No. 61/137,944, filed on Aug. 5, 2008.

(51) Int. Cl. F16M 13/00; A44B 18/00; A44B 17/00; A44B 99/00

(52) U.S. Cl. 248/342; 24/442; 24/591.1; 24/303

(57) ABSTRACT

A strap and mat that attach together for the purpose of hanging the mat for cleaning, air drying, and/or storage. The strap may also be used as a carrying strap for the rolled mat and a detachable exercise strap.

### CROSS REFERENCE TO RELATED APPLICATION

This application claims priority from provisional application No. 61/137,944 filed Aug. 5, 2008.

### BACKGROUND OF THE INVENTION 1. Field of the Invention

The present invention relates to a combined strap and exercise mat.

2. Description of the Prior Art

There is currently no method of hanging an exercise mat for cleaning, storage or air drying. Heretofore, people would roll up their sweaty yoga mats after class for storage and hand carry them, sometimes in a bag to and from their yoga, Pilates, or stretching classes and then unroll it for use again.

### SUMMARY OF THE INVENTION

According to the teachings of the present invention there is provided an attachable/detachable strap for hanging the mat for air drying, washing or storage. The strap may also be used to keep the mat securely rolled and easily carried as a shoulder strap or detached from mat and used as an exercise strap.

### BRIEF DESCRIPTION OF THE SEVERAL VIEWS OF THE COMBINED YOGA STRAP AND YOGA MAP OF THE PRESENT INVENTION

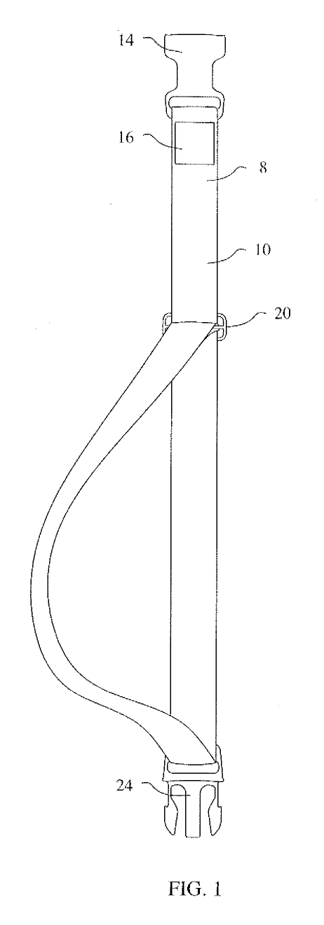

FIG. 1 is a plan view of the yoga strap constructed according to the teachings of the present invention.

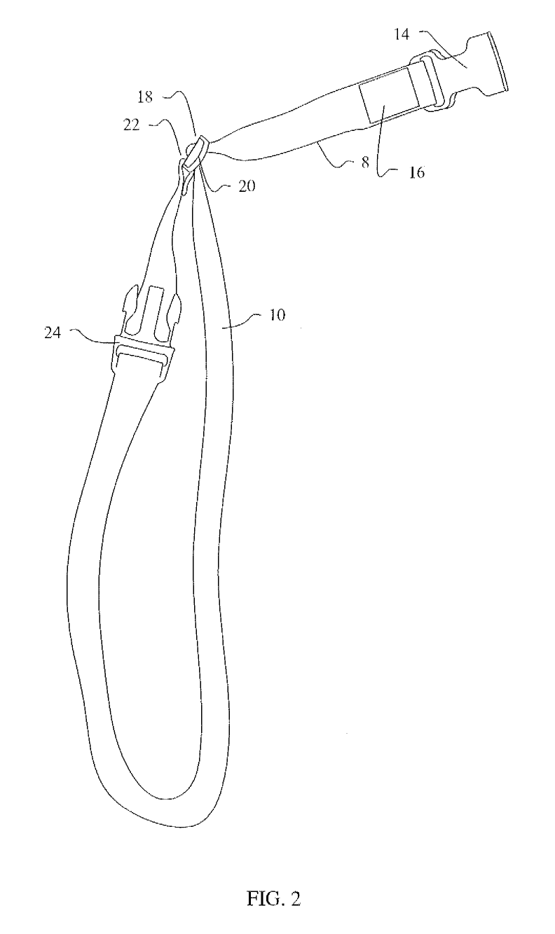

FIG. 2 is a perspective view of the strap shown in FIG. 1.

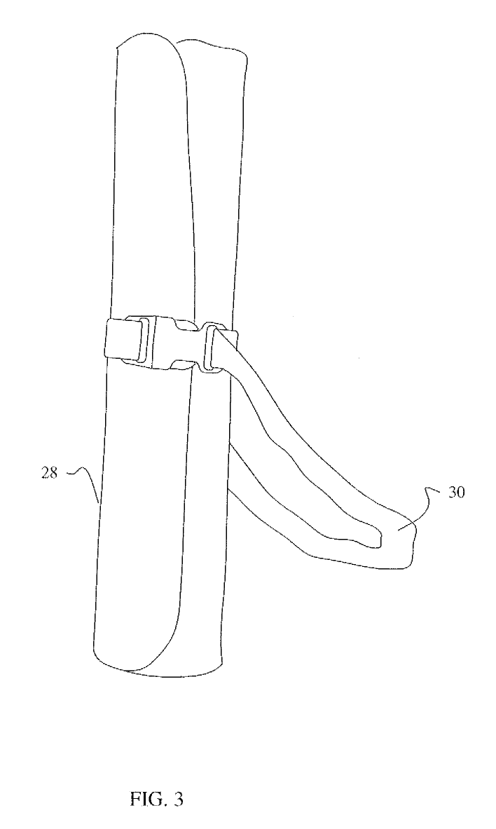

FIG. 3 is a perspective view of the strap drawn tight around a rolled up yoga mat.

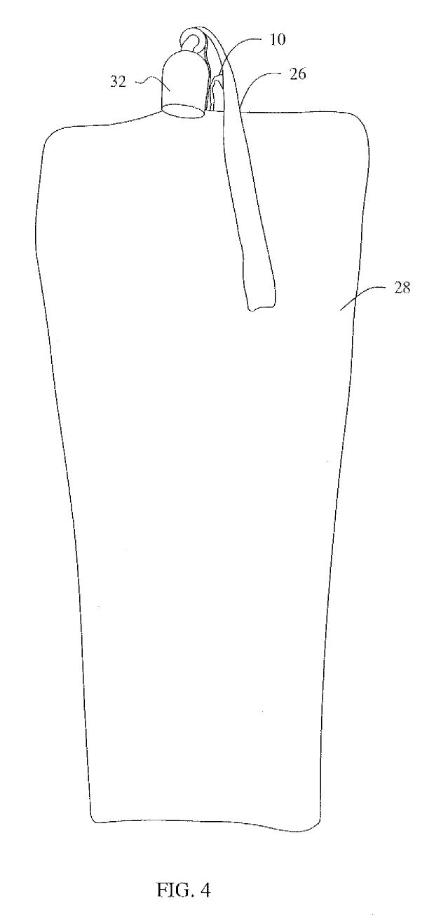

FIG. 4 is a plan view of the yoga mat unrolled and with the strap attached and hanging on a shower head.

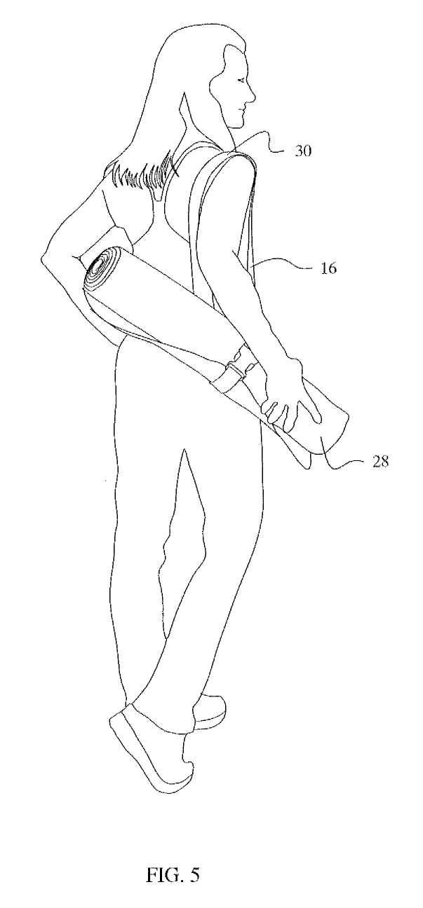

FIG. 5 is a perspective view of a person carrying the combined yoga strap and yoga mat shown in FIG. 3.

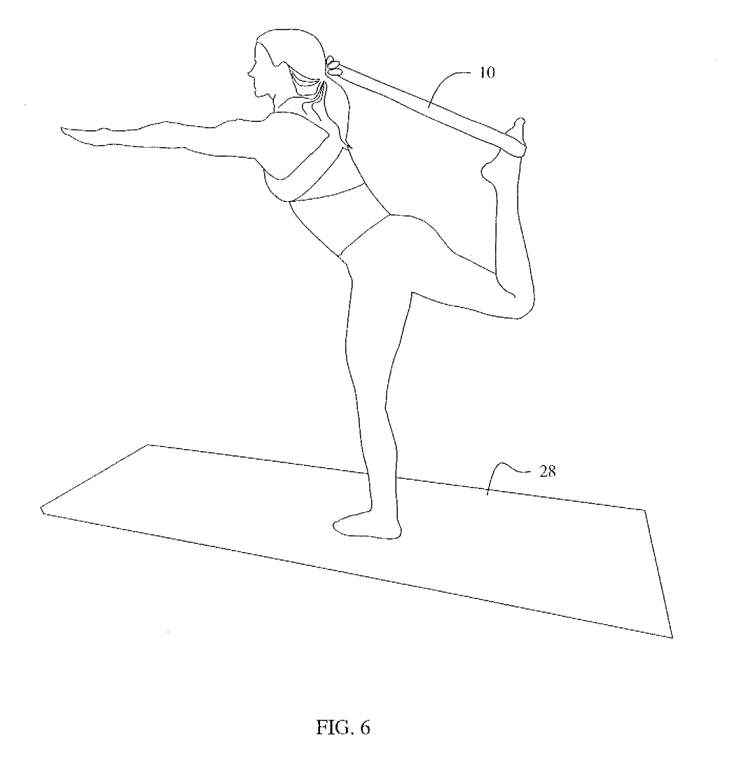

FIG. 6 is a perspective of a person using the strap in a yoga exercise.

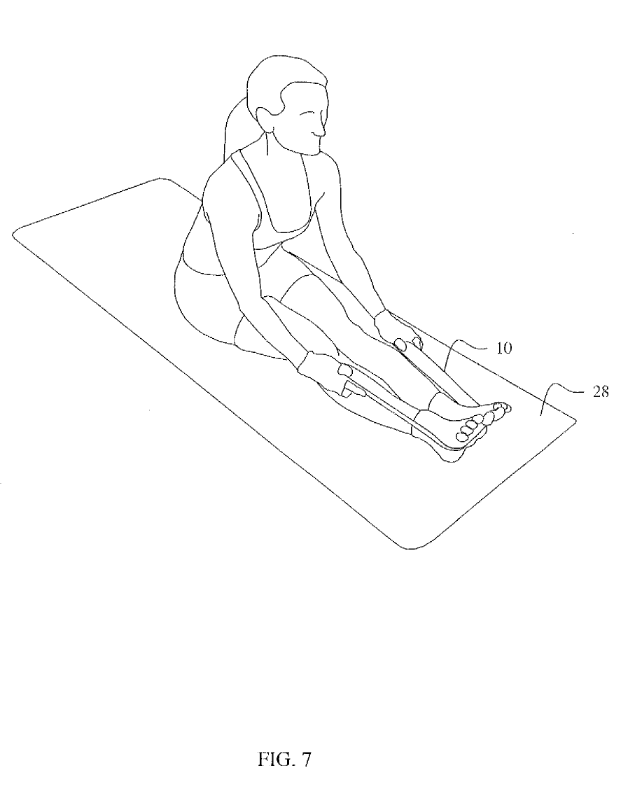

FIG. 7 is a perspective of a person using the strap in another yoga exercise.

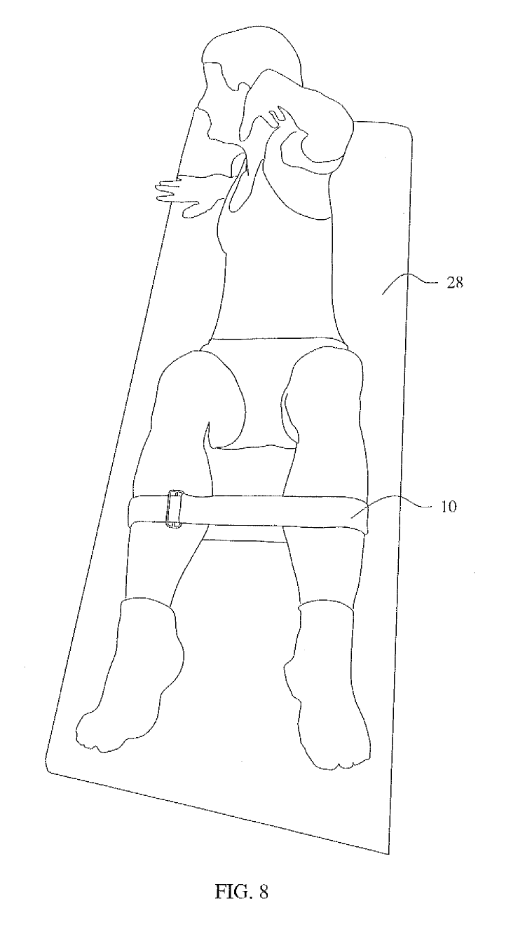

FIG. 8 is a perspective of a person using the strap in still another yoga exercise.

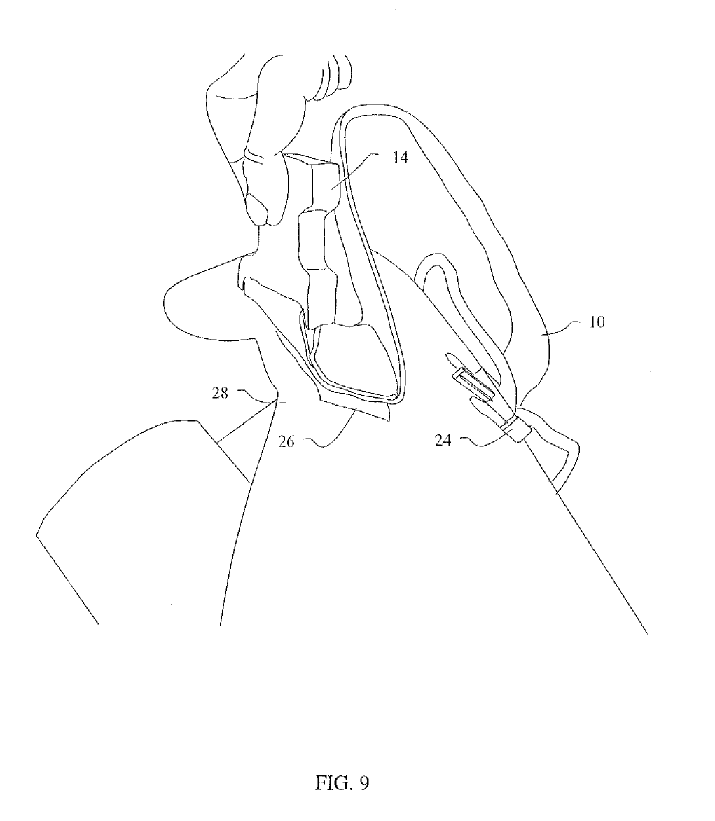

FIG. 9 is a perspective view of the mat and strap and shows the matting hook or loop material on the strap and on the mat.

### DESCRIPTION OF THE PREFERRED EMBODIMENT OF THE COMBINED YOGA STRAP AND YOGA MAT OF THE PRESENT INVENTION

In the attached figures there is illustrated a specially designed strap that attaches/detaches directly to an exercise mat and can be used to keep the mat closed, carried over the shoulder and facilitates hanging of the mat in the shower for washing/air drying/storage, and which also can be used separately as a yoga exercise strap.

As shown in FIGS. 1 and 2, one end 8 of a strap 10 is fixed to a female clip 14. A connecting means, hook or loop material 16 is fixed on the end 8 of the strap 10. The strap 10 extends through one slot 18 of a double slot buckle 20 and then through the other slot 22 of the buckle 20 and then to a male clip 24 which is slidably received on the strap 10. The strap 10 then extends to the slot 22 and is fixed to the buckle 20 thereby forming a loop. With this construction, the size of the loop can be adjusted.

The strap in an area adjacent the female clip 14 has a VELCRO™ patch 16 for mating with a VELCRO™ patch or strip 26 on a yoga mat 28 as shown in FIGS. 4 and 9. However, it does not need to be VELCRO™. It may be held together with a snap or other attaching device.

The male clip can be inserted into the female clip after the loop is pulled tight around a rolled up mat as shown in FIG. 4 and a loop 30 between the fixed male and female clips forms a shoulder strap 30 as shown in FIGS. 3 and 5.

The significant features of the exercise mat 28 with strap 10 are the following:

An attachable/detachable strap that can attach directly to the mat 28 (it can be attached with any method—Velcro, snap, magnet, hook and eye etc.) and used as a shoulder carrying strap. See FIG. 3.

The strap 10 is adjustable in length. Because the strap 10 attaches directly to the mat 28, it can be used to hang the mat for ease of washing, air drying, or storage as shown in FIG. 4, the way that the slide buckle 22 is positioned enables one to hang the mat from a shower head 32 in a fixed position which will not slide off the shower head.

When the strap is removed from the mat it can be used as an exercise strap. See FIGS. 6, 7 and 8. The strap 10 has the buckle 22 so it can be an adjustable closed loop for the purpose of making it an adjustable exercise strap.

The strap can be made from any material and the exercise mat can be made from any material.

The combined strap and mat has several advantages described below:

When people do yoga, they tend to sweat a lot which makes the mat wet with perspiration. At the end of the class, they roll up their mat and tie it into this roll or place it into a carrying bag. Unfortunately, this does not allow the mat to dry out and facilitates bacteria growth which makes the mats dirty and smelly and overall unhygienic.

When a user does wash their mats, the mats tend to be lying down on a surface which also makes it difficult for the mat to thoroughly dry.

Applicant's strap enables you to hang the mat to allow air to circulate around the entire mat to fully air dry it and resist the growth of bacteria and mildew. It also facilitates easier washing by being able to hang it in the shower. The ability to hang the mat also facilitates storage. Currently in a health club or studio where many mats are being stored, they are stored in a rolled up state which makes them bulky and takes up a lot of area. Being able to hang the mats stacked on a peg unrolled will facilitate less area required for storage.

Additionally, the current yoga straps used in performing exercise are generally made with two metal circles or D shape figures through which the other end of the strap is woven. The problem with this construction is that when you apply outward pressure on the closed strap during an exercise the strap will often slip with those buckles causing it to enlarge and defeating the purpose of the buckled strap.

Applicant's strap 10 has a locking mechanism so that when pressure is applied during exercise, the strap 10 will not slip and lengthen unintentionally.

What is claimed is:

1. A strap for attaching directly to an exercise mat to facilitate hanging the mat for washing, air drying and storage.

2. The strap of claim 1 having fastening means for connection to mating fastening means on a mat.

3. The strap of claim 2 wherein said fastening means is selected from one of hook and loop material, mating snaps, magnet and magnetizable material or hook and eye or any other interlocking mechanism.

4. The exercise mat of claim 4 wherein said mating fastening means is mounted
to said mat near at least one end thereof.

5. The combined strap and exercise mat of claim 5 wherein said fastening means is selected from one of hook and loop material, mating snaps, magnet and magnetizable material, hook and eye or any other interlocking mechanism.
